(19) United States
(12) Patent Application Publication
(10) Pub. No.: US 2007/0080916 A1
(43) Pub. Date: Apr. 12, 2007

(54) Circuit for addressing electronic units

(76) Inventors: Augusto Nascetti, Roma (IT); Walter Rutten, Linnich (DE)

Correspondence Address: PHILIPS INTELLECTUAL PROPERTY & STANDARDS, P.O. BOX 3001, BRIARCLIFF MANOR, NY, 10510, US

(21) Appl. No.: 10/578,446

(22) PCT Filed: Nov. 4, 2004
(86) PCT No.: PCT/IB04/52298

§ 371 Date: May 8, 2006

(30) Foreign Application Priority Data
Nov. 11, 2003 (EP) 03104144.5

(51) Int. Cl. G09G 3/36

(52) U.S. Cl. 345/90

(57) ABSTRACT

The invention relates to an addressing circuit for an array arrangement (100) of electronic units (101), which may be, for example, pixels of an X-ray detector. Every pixel (101) is connected to a spatially adjacent shift register (110), the shift registers (110) being connected in turn column-wise in series and also being connected to a common clock line (111,114). A trigger signal fed via an external trigger line (113) is passed by the shift registers (110) from row to row for every clock signal on the clock lines (111,114). In this process, triggered shift registers (110) activate the associate pixels (101) so that they can be read out via read-out lines (105) that extend column-wise.

The invention relates to an array arrangement comprising at least one group of electronic units, for example radiation sensors, and comprising an addressing circuit via which an activation signal can be sequentially fed to the units of the group. It furthermore relates to a radiation detector, such as, in particular, a display device comprising such an array arrangement.

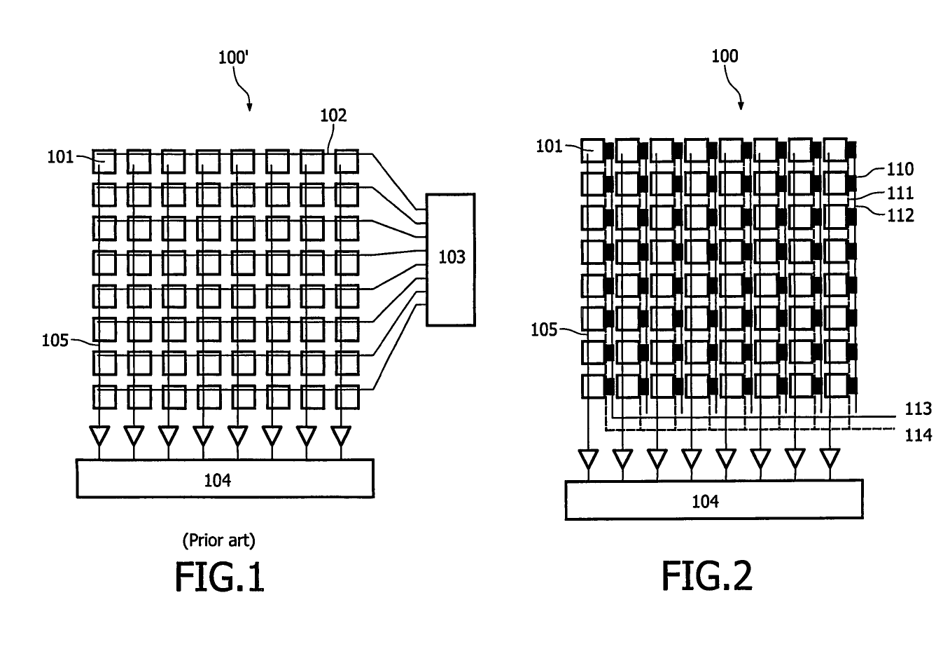

Array arrangements of electronic units, that is to say arrangements of spatially two-dimensionally or three-dimensionally distributed electronic components are to be found in various electronic systems. They include, for example, matrix displays having active light-emitting elements or CCD chips of digital cameras. Flat dynamic X-ray detectors (FDXD) in which sensitive detector elements (pixels) that are sensitive to light or X-rays are arranged in a distributed manner in one plane (cf. for example, EP 434 154, EP 440 282) will be considered below as representative. The interconnection of such X-ray detectors that is of interest for the present invention is shown diagrammatically in FIG. 1. In this Figure, the individual detector elements or pixels 101 are to be seen arranged in grid form, only eight rows and columns being shown of normally several hundreds or thousands for reasons of clarity. At the side of the field of detector elements 101 is an addressing circuit 103 from which addressing lines 102 proceed that each extend along one row of the detector elements and make contact with all the detector elements contained in said row. Furthermore, the detector elements 101 are each connected column-wise to a read-out line 105 that is routed to a read-out circuit 104. In order to read out the sensor signals (for example, accumulated charges) generated in the pixels 101 during the operation of such an arrangement, there are applied sequentially to the addressing lines 102 via the addressing circuit 103 activation or addressing signals that induce the pixels 101 connected to the respective line to apply their signal to the associated read-out line 105. In this way, the entire detector array can be read out row for row. A problem in the known structure is that a large number of external address lines have to be provided, which number is equal to the number of lines. Furthermore, the addressing circuit occupies at least one edge of the detector array so that the abutment of more than two detector arrays in the corresponding direction cannot be gap-free.

Against this background, it is an object of the present invention to provide an alternative activation or addressing method for array arrangements of electronic units, which method can be implemented more simply in regard to the wiring complexity.

Said object is achieved by an array arrangement having the features of claim 1, by a radiation detector having the features of claim 10, and also by a display device having the features of claim 11. The subclaims contain advantageous refinements.

The array arrangement in accordance with the invention contains at least one group of electronic units (for example, a column of sensor pixels) and also an addressing circuit via which an activation signal can be fed sequentially to the units of the at least one group. In said array, the addressing circuit contains the following components:
a) Driver units, every driver unit being disposed spatially closely adjacent to (at least) one electronic unit and being electrically connected to said unit. In this connection, “closely adjacent” means, in particular, that the coupling line between the driver unit and the electronic unit is short and, for example, does not run past other electronic units (or at best past a few). Typically, the driver unit is situated in the space between two adjacent electronic units. Furthermore, every driver unit has at least one connection input and at least one connection output, it being designed to receive a trigger signal applied to the connection input and, after receiving the latter, to deliver an activation signal for a certain time duration to the at least one electronic unit connected to the driver unit, and also to pass the trigger signal to the connection output.
b) Connection lines that link the connection inputs and connection outputs of the driver units in series with one another. That is to say that all the driver units assigned to a group are connected in series, the connection output of a preceding driver unit being coupled to the connection input of the subsequent driver unit. In this connection, the connection output may be absent in the case of the last driver unit of the series since no further driver unit follows.

In the array arrangement described, the electronic units of a group may be activated sequentially by applying a trigger signal to the connection input of the first driver units connected in series. On the basis of said trigger signal, the first driver unit delivers an activation signal to the associated electronic unit (or to a plurality of associated units) and passes on the trigger signal to the next driver unit in the series, where the process described is repeated. In this way, the trigger signal passes along the series connection of driver units and initiates an activation of the connected electronic unit at every driver unit, it being possible for this process to proceed autonomously or under the control of an external clock. An advantage in this connection is that an initiating trigger signal has to be fed externally only to the first element in the group. The sequential activation of the electronic units internally inside the array arrangement then proceeds without trigger signals fed from the outside still being needed. Instead of the external addressing lines for every element in a group that are necessary in the case of known X-ray detectors, only a single such line is consequently needed. The lower number of global control lines and the mainly local interconnection of the array arrangement results under these circumstances in a simplified layout of the circuit and consequently in a higher process yield. At the same time, the lines between the distributively arranged driver units and the electronic units is short, with the result that only a low capacitive load arises for the respective driver stages. The latter may consequently be of smaller design. A further advantage is that the number of the control lines to be routed to the outside is independent of the array size and that no space has to be kept available at the edge of the array for control circuits, which facilitates the gap-free abutment of a plurality of array arrangements.

The processing of the trigger signal undertaken by the driver units may take place, as already mentioned, “autonomously”, ie. determined solely by the occurrence of the trigger signal itself and by internal parameters of the driver unit. Thus, for example, the time duration for which a driver unit delivers an activation signal after receiving a trigger signal can be generated or “measured” internally in the driver unit. Preferably, however, the driver units are connected to a common clock line via which an external clock signal is fed. On the one hand, this simplifies the circuit complexity for the driver units and, on the other hand, a precise synchronization of the sequential activation of electronic units of different groups (for example, different columns of a detector array) is ensured. Optionally, a voltage supply line (or ground line) on which clock signals are superimposed may also be used as a clock line.

In addition, the driver units may optionally contain further terminals via which their functions may be influenced in a more systematic manner. Thus, they may contain, in particular, an enable line for controlling the time duration for which the activation signal is delivered to the electronic unit. Furthermore, the driver units may be connected to at least one line for supplying at least one (analog) control voltage. Such control voltages can be used, in particular, as an activation signal for the electronic units and have (for instance, compared with the operating voltage of the driver units) the advantage that they can be conditioned in a low-noise form.

The electronic units may, in principle, be disposed as desired spatially. It is preferable, however, if they are disposed two-dimensionally in a regular pattern. A typical example of this is provided by hexagonal arrangements or rectangular grid-type arrangements of sensor elements on flat dynamic X-ray detectors.

Preferably, the array arrangement contains more than one group of electronic units, it being possible for the members of a group each to be activated sequentially by the addressing circuit. It is particularly preferable if the array arrangement contains a plurality of equally large groups (that is to say containing the same number of electronic units), the electronic units in the groups each being disposed in a similar way. In this case, the same internal linking pattern can be used for every group.

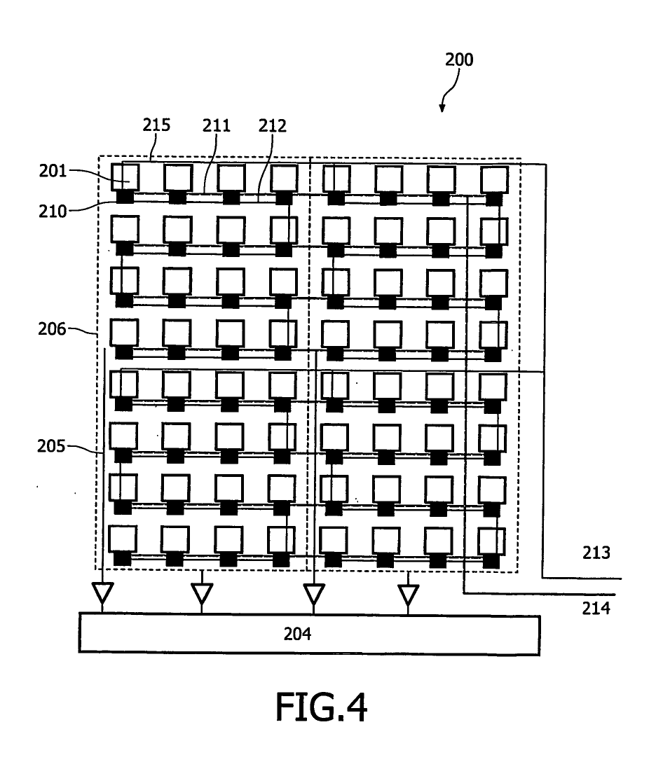

In particular, in the abovementioned case, the electronic units of a group may be disposed linearly (for example, in columns (cf. FIG. 2), it being possible for a line, for example, in a hexagonal arrangement also to extend in zigzag form) or in block form (cf. FIG. 4).

The electronic units of a group may, in particular, be sensor elements, such as, for example, radiation sensors for electromagnetic radiation (light, X-rays, γ rays, etc.), particle radiation or the like, that are connected to a common read-out line. Since the units of the group are activated consecutively via the address circuit, they can be read out sequentially via the same read-out line without affecting one another, it being a requirement that the units apply their signal to the read-out line during an activation.

In accordance with another refinement of the array arrangement, the electronic units are active light radiators, for example light-emitting diodes of a matrix display. In this case, the sequential addressing via the addressing circuit is used to transmit luminance values to be displayed systematically to individual units. Alternatively, the electronic units may also be electronically controlled light switches, such as are to be found, for example, in liquid-crystal displays (LCDs).

In terms of circuitry, the driver units of the addressing circuit can be implemented in various ways. Preferably, they contain at least one shift register that receives a signal present at a connection input during a clock signal and passes it immediately or with minimum delay to its output. If only one shift register is present, the next shift register, which receives the signal in its turn with the next clock, is typically connected to its (connection) output. If, on the other hand, the driver unit comprises two shift registers connected one behind the other, it can receive a trigger signal from the connection input during the first clock signal and provide an activation signal. During the second clock signal, it can then pass the activation signal to the second shift register and take back the activation signal again. It is only during the third clock signal that the next electronic unit is activated in this embodiment. Advantageous in this case is the fact that the duration of the activation is determined by the interval between the first and second clock signal and can therefore be chosen independently of the time between the activation of two consecutive electronic units, which activation is defined by the interval between the second and the third clock signal.

The array arrangement may be implemented as a microelectronic, integrated circuit, in particular in silicon technology (for example from amorphous, polycrystalline or monocrystalline silicon).

The invention furthermore relates to a radiation detector, such as, in particular, an X-ray detector, that serves to detect radiation (electromagnetic radiation, particles etc.) in a positionally resolved manner and that contains an array arrangement of the above-described type, the individual radiation sensors forming the electronic units of the array arrangement.

The invention furthermore relates to a display device, such as, for example, a matrix display, that contains an array arrangement of the above-described type, the electronic units of the array arrangement being formed by active light radiators or by light switches.

These and other aspects of the invention are apparent from and will be elucidated with reference to the embodiments described below.

In the Drawings:

FIG. 1 shows an X-ray detector comprising an addressing system in accordance with the prior art;

FIG. 2 shows the X-ray detector of FIG. 1 comprising an addressing system in accordance with the invention;

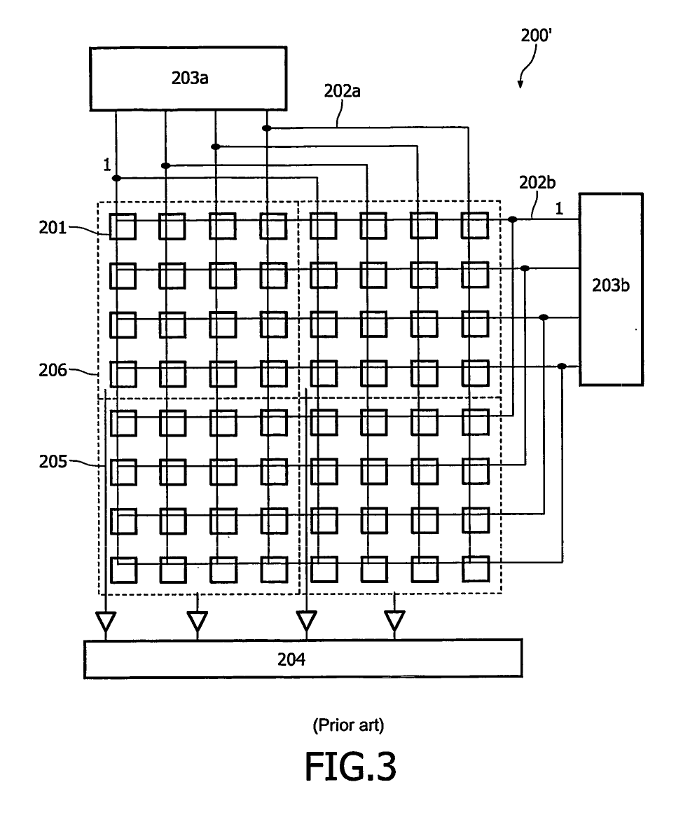

FIG. 3 shows an X-ray detector comprising a two-dimensional addressing system in accordance with the prior art;

FIG. 4 shows an X-ray detector according to FIG. 3 with an addressing system in accordance with the invention.

The structure of a flat X-ray detector FDXD 100′ shown diagrammatically in FIG. 1 and known from the prior art has already been explained in the introduction to the description. It is characterized in that the picture sensors or pixels 101 disposed in the form of a matrix are sequentially addressed or activated via address lines (102), routed from the outside, of an addressing circuit 103, it being possible for their signals to be detected via read-out lines 105 of a read-out circuit 104 that extend in the form of columns.

FIG. 2 shows the modification in accordance with the invention of the addressing circuit of FIG. 1 for the X-ray detector 100. In this case, a driver unit 110, designed in the present case as a shift register, is disposed at every pixel 101. Every shift register 110 is connected to a clock signal via lines 111 extending in the column direction, which clock signal is fed from the outside via a clock line 114. Furthermore, every shift register 110 is connected to the adjacent shift register of the same column via connecting lines 112 extending in the column direction, the connection output of the driver unit 110 (which is situated in the Figure at the top of the driver unit 110 in each case) is connected in each case to the connection input of the next-higher driver unit 110. In the lowest peripheral row in FIG. 2, the connection inputs of the shift registers 110 are all connected to an external trigger line 113. Optionally, a plurality of external trigger lines may also be provided for this purpose.

As in the case of FIG. 1, all the pixels 101 are furthermore coupled to a read-out circuit 104 via read-out lines 105 in column form.

The reading out of the signals (for example, charges) accumulated in the pixels 101 during an X-ray exposure is initiated by an external trigger signal (for example, a high voltage level) on the row 113. Said trigger signal first reaches only the shift register 110 of the lowest row of the detector element 100 in which it is received during a first subsequent clock signal and which then causes it to deliver an activation or addressing signal (for example, a high voltage level) to the pixel 101 to which the shift register is coupled. Otherwise than shown in FIG. 2, a shift register could in this connection also be connected to a plurality of pixels 101, in particular to two adjacent pixels of the same row. The shift register could then activate the two pixels simultaneously so that the addressing circuit would in total manage with about half the number of shift registers.

The pixel 101, activated as described, in the lowermost row makes, because of its activation, a connection to the respective read-out line 105, with the result that its video signal can be read out by the read-out circuit 104.

Reading-out of the remaining rows is then controlled stepwise by the clock signal on the external clock 114 and the internal clock lines 111. During the first clock signal, the shift registers of the lowest row have received, as explained, the trigger signal and passed it immediately or with minimum delay to the shift registers of the second row. During the next clock signal, the trigger signal is received by the shift registers of the second row (and passed to the third row) whereupon these activate the pixels of the second row for the purpose of reading-out. With every further clock signal, the next row of pixels is addressed and read out in a similar way until the entire array 100 has been covered.

Otherwise than as shown in FIG. 2, every driver unit 110 could also optionally have further terminals in addition to the connection input and the clock signal. In particular, they could have an “output enable” or “enable input” that would be linked to the activation information stored in the shift register and would only permit generation of the activation signal if an enable signal is present at it. In this way, the duration of the activation could be chosen independently of the progress of the trigger signal (i.e. optionally shorter than the time between the activation of consecutive rows). Furthermore, “analog control voltages” could also be fed to the driver units for use as the signal level that is passed to the pixel by the driver unit. In contrast to the operating voltage of the driver units, such a control voltage can be conditioned to be very low in noise.

An advantage of the type of addressing described is that only a few lines (two in the example shown) that have to be connected overall to all the pixels or pixels of a peripheral row are necessary for reading out the array 100. The number of lines brought out externally consequently does not depend on the size of the array. The implementation of the few external lines is, as a rule, technically much simpler than that of many independent lines, as in an arrangement according to FIG. 1.

FIG. 3 shows a further type of addressing from the prior art for an X-ray detector FDXD 200′(cf. EP 1 313 307 A1, EP 1 312 938 A1). In this detector, those pixels 201 that are connected to the same read-out line 205 form a two-dimensional area of a so-called super pixel 206. In the example shown in FIG. 3, four such super pixels 206 (broken framing) are present each having 4×4=16 pixels. To activate the pixels 201 of a group 206 formed by a super pixel sequentially, a two-dimensional addressing system is used. In this case, every pixel 201 is coupled to two addressing lines 202a, 202b that are connected in the pixel to a control element such as, for example, an AND gate (not shown). The addressing lines 202a, 202b are controlled from the edge of the detector element 200′ via addressing circuits 203a, 203b. If, for example, an addressing signal is set on the two lines characterized by “1”, all the pixels 201 are activated (that is to say connected to the associated read-out line 205) that are connected to these two lines. In FIG. 3 this is the pixel situated in each case in the left-hand upper corner of the super pixel 206. In this type of addressing, the number of “external” addressing lines is less than in the case of the addressing system in accordance with FIG. 1, but the routing of the lines inside the active area is more complicated.

FIG. 4 shows a detector arrangement 200 having an addressing system modified in accordance with the invention. In this case, there is again disposed at every pixel 201 a shift register 210 that is connected to the pixel 201 in order to be able to activate or address it. An external trigger line 213 is routed to a first pixel 201 in each case of every super pixel 206 via the chip surface; in the example shown, this is the pixel 201 situated in the left-hand upper corner of a super pixel 206. Furthermore, all the shift registers 210 of a super pixel 206 are interconnected in a series circuit by internal connecting lines 212, the latter extending, for example, meander-like over the surface of a super pixel 206.

All the shift registers 210 are furthermore connected via internal clock lines 211 to an external clock line 214. Finally, the pixels of a super pixel 206 are all connected, as in the case of FIG. 3, to the same read-out line 205.

Reading-out of the detector 200 again starts with a trigger signal on the external trigger line 213. This is conveyed to all the first pixels 201 of every super pixel 206, whereupon the latter can be read out. With every clock signal on the clock lines 214, 211, the clock signal is then conveyed by a shift register to the next one, with the result that all the pixels 201 of any super pixel 206 can be “scanned” in turn.

The manner of addressing described can, in principle, be achieved with the same technology as in the case of conventional FDXDs, that is to say as thin-film electronics. However, it is particularly suitable for detectors that are based on crystalline silicon (for example, CMOS) or polycrystalline silicon technology.

1. An array arrangement (100, 200) comprising at least one group (206) of electronic units (101, 201) and comprising an addressing circuit via which an activation signal can be sequentially fed to the units of the group, wherein the addressing circuit contains the following components:
a) driver units (110, 210) that are each disposed adjacently to an electronic unit (101, 201) and connected to it, wherein every driver unit has at least one connection input and at least one connection output and is designed to receive a trigger signal applied to the connection input and, after receipt thereof, to deliver an activation signal for a certain time duration to the associated electronic unit, and also to pass the trigger signal to the connection output;
b) connecting lines (112, 212) that link the connection inputs and connection outputs of the driver units (110, 210) serially to one another.

2. An array arrangement as claimed in claim 1, characterized in that the driver units (110, 210) are connected to additional lines, preferably to a clock line (111, 114; 211, 214) for transmitting a clock signal, to an enable line for controlling the time duration of the activation signal, and/or to at least one line for supplying at least one control voltage serving as an activation signal.

3. An array arrangement as claimed in claim 1, characterized in that the electronic units (101, 201) are disposed two-dimensionally in a regular pattern.

4. An array arrangement as claimed in claim 1, characterized in that it contains a plurality of equally large groups (206) in which the electronic units (101, 201) are each disposed in a similar way.

5. An array arrangement as claimed in claim 1, characterized in that the electronic units of a group are disposed linearly (101) or in block fashion (201).

6. An array arrangement as claimed in claim 1, characterized in that the electronic units of a group (206) are sensor elements (101, 201), in particular radiation sensors, connected to a read-out line (105, 205).

7. An array arrangement as claimed in claim 1, characterized in that the electronic units are active light radiators or light switches.

8. An array arrangement as claimed in claim 1, characterized in that the driver units (110, 210) contain at least one shift register.

9. An array arrangement as claimed in claim 1, characterized in that it is implemented as an integrated circuit, in particular in silicon technology.

10. A radiation detector, in particular an X-ray detector, containing an array arrangement (100, 200) of sensor elements (101, 201) as electronic units, the array arrangement being configured as claimed in claim 1.

11. A display device containing an array arrangement (100, 200) of active light radiators or light switches as electronic units, the array arrangement being configured as claimed in claim 1.
